(19) United States
(12) Patent Application Publication
(10) Pub. No.: US 2016/0379163 A1
(43) Pub. Date: Dec. 29, 2016

(54) SYSTEMS AND METHODS FOR TRACKING SHIPMENTS

(71) Applicant: INTEL CORPORATION, Santa Clara, CA (US)

(72) Inventors: Michael A. Johanson, Chandler, AZ (US); George P. Moakley, Phoenix, AZ (US)

(73) Assignee: INTEL CORPORATION, Santa Clara, CA (US)

(21) Appl. No.: 14/748,604

(22) Filed: Jun. 24, 2015

(51) Int. Cl. G06Q 10/08; H04W 88/16; H04W 84/04

(52) U.S. Cl. CPC G06Q 10/0833; H04W 84/04; H04W 88/16

(57) ABSTRACT

An apparatus for tracking a shipment includes an Internet of Things (IoT) gateway that includes a communications link to an IoT infrastructure and a communications link to a number of IoT devices. Each of the IoT devices is disposed proximate to an asset, and include a communications link to the IoT gateway.

### TECHNICAL FIELD

The present techniques relates generally to devices for use in shipping networks. More specifically the present techniques relate to devices that can be used to track packages during shipping.

### BACKGROUND

The worldwide logistics industry is a multitrillion dollar industry and the proliferation of Internet of Things (IoT) technologies creates the opportunity to enhance the instrumentation of the assets to include the ability to recognize and manage their associations amongst themselves from origin to destination. Today's information systems manage these co-associations within centralized information systems, without significant instrumentation.

However, this approach has fundamental limitations, and even the most sophisticated centralized information systems inevitably suffer from discrepancies between back end records and field reality. One classic example is lost luggage due to human error, e.g., placed on a wrong luggage cart, after updating a centralized systems that the luggage was placed on the correct luggage cart. Another example, would be for tracking inbound capital for plants. As multi-shipment capital is received, centralized information systems note when the last package arrives and at which point the subsets are assembled for installation only to find something has been misfiled in the warehouse, damaged in transit, or otherwise cannot be found or used immediately. The probability of such a disparity between physical reality and centralized information records increases with the number of assets co-associated with a complex shipment.

### BRIEF DESCRIPTION OF THE DRAWINGS

FIG. 1 is a block diagram of a system for tracking shipments using internet of things (IoT) devices, in accordance with an embodiment.

FIGS. 2A and 2B are a schematic example of IoT devices used to track a shipment and alert on a lost package, in accordance with embodiments.

FIG. 3 is a schematic of an example of using IoT devices to track a shipment that has been diverted due to bad weather, in accordance with an embodiment.

FIG. 4 is a block diagram of another system for tracking shipments using internet of things IoT devices, in accordance with an embodiment.

FIG. 5 is a block diagram of another system for tracking shipments using internet of things IoT devices, in accordance with an embodiment.

FIGS. 6A and 6B are a top view and a side cross sectional view of an internet of things (IoT) device that may be used in an embodiment.

FIG. 7 is a block diagram of IoT devices in communication with an IoT gateway, in accordance with embodiments.

FIG. 8 is a method for tracking shipments with IoT devices, in accordance with embodiments.

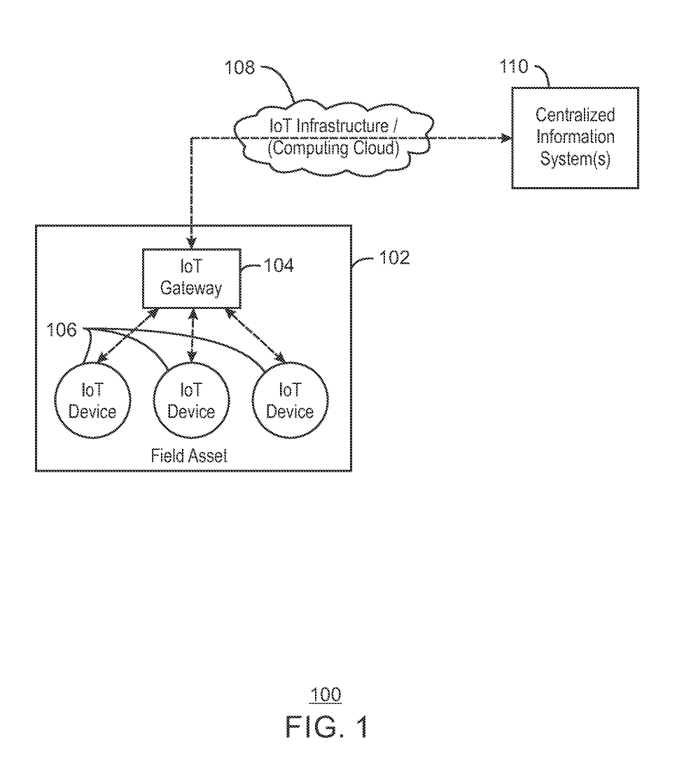

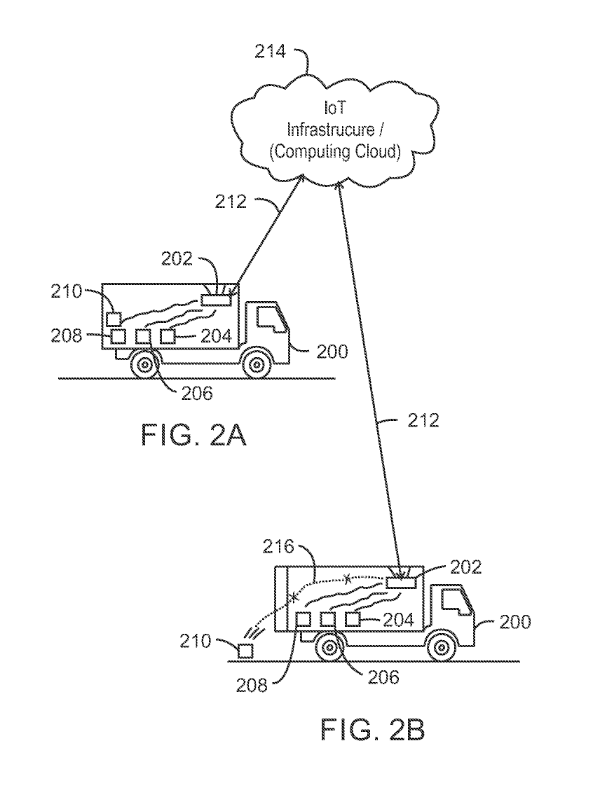

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The internet of things (IoT) is a concept in which a large number of computing devices are interconnected to each other and to the Internet to provide functionality and data acquisition at very low levels. Early IoT deployments have been used to do an incrementally better job of collecting information at the edge of delivery infrastructures to feed centralized information systems. However, it would be more effective to create edge intelligence that collects and processes information at the edge, eliminating inevitable discrepancies between centralized information system records and field reality, e.g., lost packages, and allowing business problems and opportunities to be effectively addressed. For example, by making the assets themselves smart enough to find and recognize each other in the warehouse this problem may be addressed because we are no longer relying solely on potentially erroneous centralized system records.

Embodiments described herein provide an autonomous edge intelligence consisting of one or more IoT gateways and associated smart sensors, or IoT devices, as a separate computational space from other tracking tools, such as central inventory databases. The computational space supports new classes of applications that collect, process, analyze, and utilize information locally, dynamically forms ad hoc networks with peer intelligences and infrastructure services as needed.

This may support goal oriented behavior in order to enable new optimizations for operational systems. For example, a loading dock handles inbound shipments from multiple independent trucking companies carrying chartered freight from multiple shipping companies that have chartered the trucks. Not every shipment has the same scheduling requirements, not every shipment is compatible with every loading dock bay, and not every truck is compatible with every loading dock bay. If autonomous edge intelligences were applied to the loading dock, the trucks (each the edge of a different trucking company cloud) and the shipments (each the edge of a different freight company cloud), then the shipments, vehicles, and warehouse could discover each other, form an ad hoc network, and iteratively work through the most efficient schedule that best fulfills each unit's service level agreements, with trucks instructed to save fuel by slowing down or scheduling refueling rather than arriving and idling.

The autonomous edge intelligence starts with stateful gateway devices enabled to locally collect, analyze, and process raw data in the field before forwarding results to centralized systems. By contrast, a stateless gateway device would simply store and forward information without local retention, thereby unable to derive any trend related secondary information. Stateful is defined as storing previously known or provisioned configurations about the environment in which it is placed, e.g., shipping data, to make informed decisions about what is collected. It may be increased in sophistication to support goal oriented behavior through ad hoc relationship formation with peer edge intelligent gateways and infrastructure services, for example, to help meet service level agreements.

The basic principle is to affix sensors, e.g., as IoT devices, to each asset in a shipment. An intelligent stateful computing device, e.g., an IoT gateway, provides a centralized information system with intelligence at the edge that can independently measure and verify environmental conditions from the sensors, such as location, acceleration or shock, humidity, temperature, and the like, and determine a course of action, such as issuing an alert based on various events that may occur. In some embodiments, the systems may recognize each other and assert their location and integrity. In this way, it may be determined that all co-associated assets are intact and that the right units are being collected as efficiently as possible, in transit and within our warehouses.

The use of the IoT devices and IoT gateways pushes functionality to the edge of the information structure, instead of relying solely on a centralized intelligent system. This may allow for querying of the asset about location, handling, etc., resulting in the most up-to-date information without relying on manual intervention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM), random access memory (RAM), magnetic disk storage media, optical storage media, flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a system 100 for tracking shipments using internet of things (IoT) devices, in accordance with an embodiment. The item to be tracked is a field asset 102, which may be a shipment, a part of a shipment, a pallet of goods, a railcar, a number of railcars, a truck, a remote processing unit, and the like. An IoT gateway 104 provides a computing device that continuously monitors the field asset 102.

The use of the IoT gateway 104 provides an autonomous edge intelligence, e.g., providing a field system that can assert a real time awareness of the state and condition of field assets rather than solely relying on centralized information system records. The IoT gateway 104 may take advantage of data generated locally, e.g., trucks generate approximately 10 mb per mile driven, for performing local analytics rather than filtering the data before forwarding snapshots to a central location. Accordingly, it may not be limited by communications pathways that are often expensive, constrained, and/or unreliable in order to solve a problems with an asset.

The field asset 102 may have a number of sensors, or IoT devices 106, coupled to the IoT gateway 104 to determine parameters such as location, temperature, impact, humidity, status, or any other property. The parameters may be externally set, for example, the asset is being transported, is subjected to environmental conditions, or has qualities whose changes must be tracked.

The IoT devices 106 collect or generate raw information streams with some level of local processing, e.g., at particular sampling rates and thresholds, that are passed to the IoT gateway 104. The IoT gateway 104 processes the information form the IoT devices 106 for transmission through an IoT infrastructure 108 or other computing cloud, to a centralized information system 110.

The information processing by the IoT gateway 104 can include any number of activities, such as data reductions and normalizations. Further activities that can be performed by the IoT gateway 104 include threshold management and local analytics to diagnose particular issues and recommend actions. The information collected may be exchanged with centralized enterprise systems, peer field assets, and field assets or infrastructure services from distinct computational domains to fulfill the mission programmed into the device, e.g., monitoring the status of the field asset 102, or identifying an optimized pathway to a destination, among others. The local processing of the data may decrease discrepancies between the true state of field assets and the records maintained by centralized information systems 110.

It may be useful to think of these implementations in terms of three computational domains. The first is the centralized information system 110, the second is the IoT infrastructure 108, and the third is the IoT gateway 104 and IoT device 106. The co-location and co-association of a field asset 102 with another asset, uses IoT gateways 104 and IoT devices 106 that have local intelligence to find and recognize each other and take applicable actions. In addition to direct communications, the IoT gateway 104 and IoT devices 106 may be able to find and recognize each other through IoT infrastructure 108 within a warehouse or across a computing cloud, such as the Internet. Further, the IoT devices 106 may be able to use direct communications between IoT devices 106 to establish an ad-hoc network, as described herein.

FIGS. 2A and 2B are a schematic example of IoT devices used to track a shipment and alert on a lost package, in accordance with embodiments. For example, a truck 200 may have an IoT gateway 202 installed for tracking shipments, such as packages 204, 206, 208, and 210. The IoT gateway 202 may include a wireless wide area network (WWAN) for cellular communications 212 with an IoT infrastructure 214. Each of the packages may have IoT devices with associated sensors, for example, for temperature, shock, humidity, and the like. The IoT devices may be queried at configurable intervals by the IoT gateway 202. The sensors also provide information identifying each packages 204, 206, 208, and 210, allowing the IoT gateway 202 to make the appropriate co-associations among packages 204, 206, 208, and 210.

In FIG. 2A, the truck 200 has all of the packages 204, 206, 208, and 210 loaded and reporting in to the IoT gateway 202. However, in FIG. 2B, a package 210 has been left behind. As a result, the communications link 216 between the IoT gateway 202 and the IoT device in the package 210 is broken. The IoT gateway 202 may then trigger a notification to a responsible party. This may be the driver, a customer, or both, as well as anyone who has a vested interest in the shipment would be notified allowing response to the incident.

Additionally because there is potentially more computing power in the IoT device, it may be configured to go into an “SOS” mode, e.g., broadcasting information to aid in recovery of the asset. Further, the loss of the package 210 may trigger an automatic order of a new unit to be sent to replace it without having to wait until the missing status of the item is noted at the customer's site.

Although the example shown in FIGS. 2A and 2B uses a single IoT gateway 202 on a truck 200 with IoT devices on each of the packages 204, 206, 208, and 210 it is not limited to this configuration. For example, the shipment may include pallets of packages, wherein each pallet has an IoT gateway in communication with individual IoT devices in the packages of the pallet, and in communication with the IoT gateway 202 on the truck 200. Further, the system may be used for any types of shipments, such as by railcar, ship, courier, or aircraft, among others.

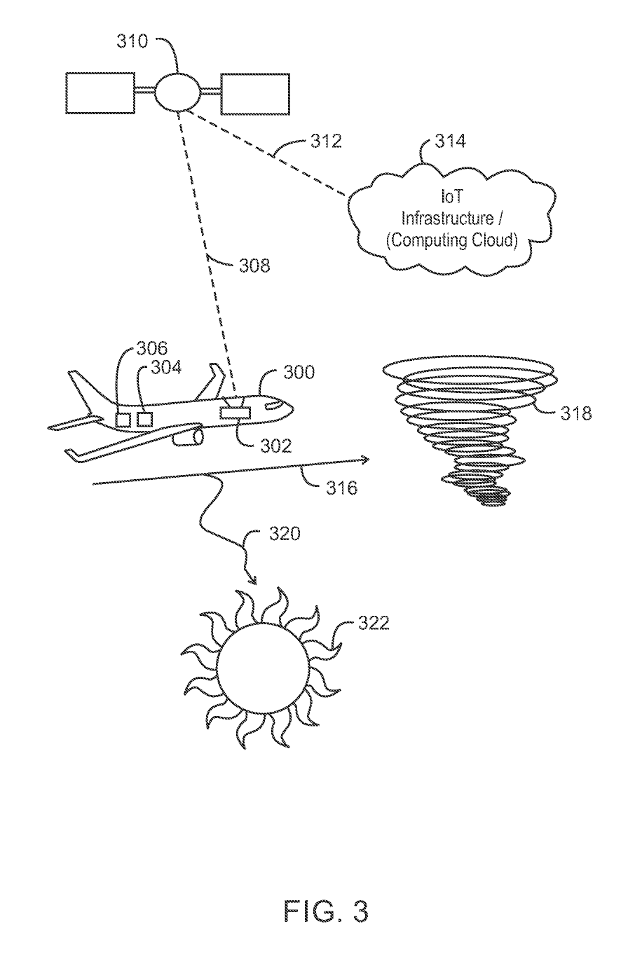

FIG. 3 is a schematic of an example of using IoT devices to track a shipment that has been diverted due to bad weather, in accordance with an embodiment. In this example, an aircraft 300 has an IoT gateway 302 that is in communication with IoT devices in individual packages 304 or 306. The IoT gateway 302 may also have a satellite link 308 to send data through a satellite 310. The satellite 310 may have a communications link 312 to an IoT infrastructure 314.

The initial route 316 of the aircraft 300 takes it into bad weather 318, and the aircraft 300 is rerouted 320 to stay in more favorable weather 322. In this scenario, the IoT gateway 302 may send a number of different alerts as actionable issues are detected. The first alert may indicate that the assets in the packages 304 or 306 have exceeded their shock tolerances due to turbulence during the flight as reported to the IoT gateway 302 by the IoT devices in the packages 304 and 306. The determination of the shock tolerances may be made by the IoT devices themselves or by the IoT gateway 302, for example, based on sensor data and content identification transmitted to the IoT gateway 302 from the IoT devices in the packages 304 and 306.

Another alert may be sent upon the rerouting 320 of the shipment. This is important from the co-association perspective because a change of route during transit could affect costs and timing of other shipments. If the asset that is being re-routed happens to be a shipment that other shipments depend on for project completion, a decision could be made to de-prioritize the other shipments. Again, this could result in cost-savings from a customer's perspective as the shipment method for the other shipments may change from expedited to standard shipping.

As another example, if the shipment included perishable goods currently in route to a distributor, the re-routed goods may become unusable by the time they reach the original destination. De-associating the goods from other items currently in transit, and shipping them to a distributor at a new destination may allow for the shipment to be sold without substantial spoilage.

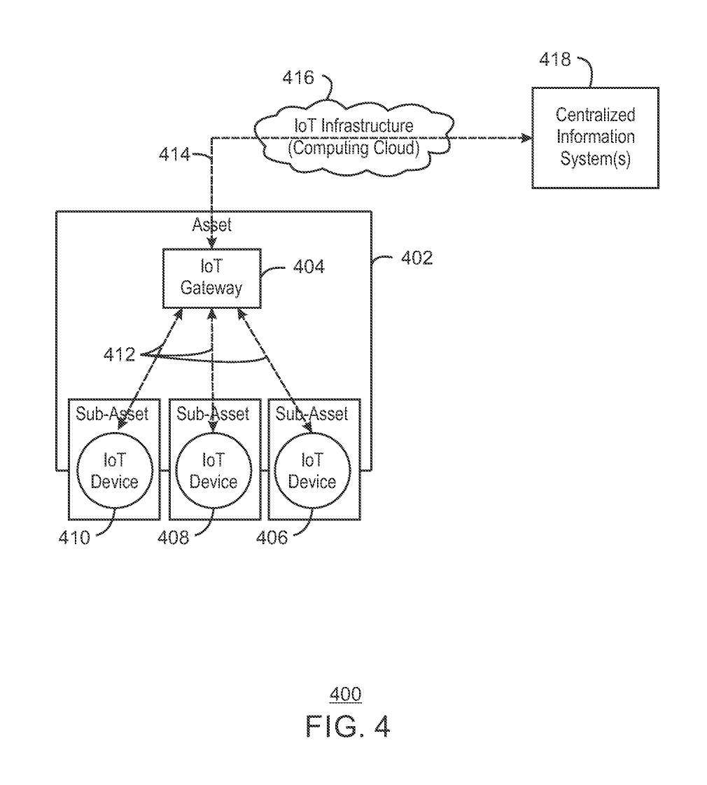

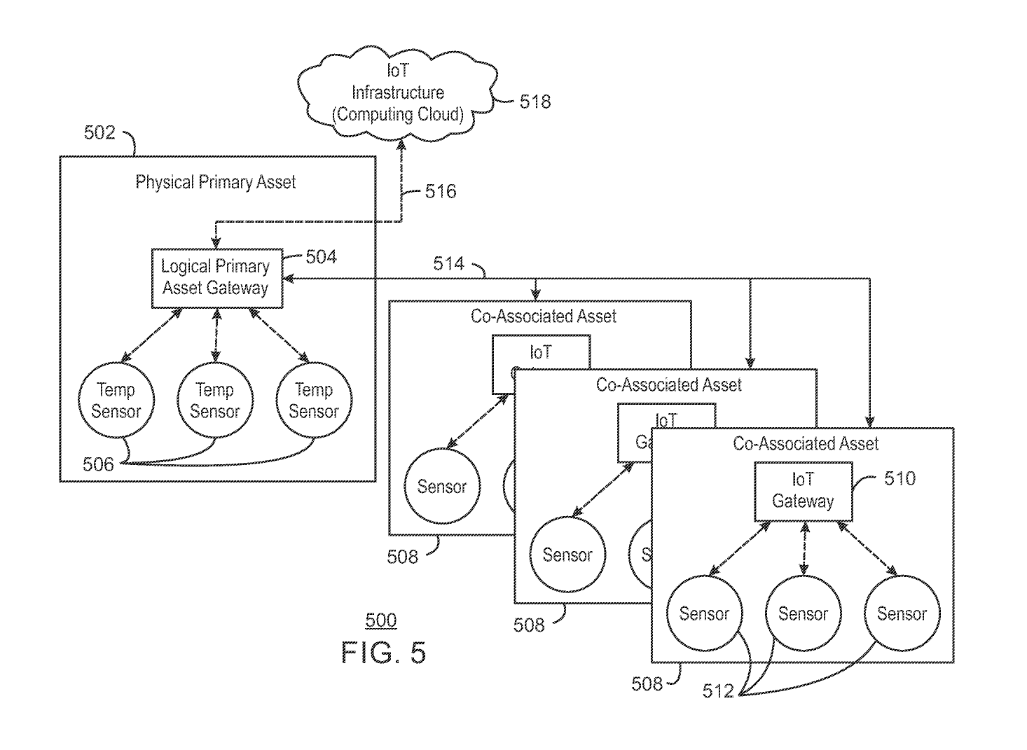

The above are just a few scenarios in transportation and logistics market where a parent-child type architecture could be utilized to address the blind spot that exist in managing the co-association of shipments while in route. These examples may be performed by the architectures described with respect to FIGS. 4 and 5.

FIG. 4 is a block diagram of another system 400 for tracking shipments using internet of things IoT devices, in accordance with an embodiment. In this example, the asset 402 may be a pallet that has an IoT gateway 404. The pallet has a number of packages, or sub-assets, that are each equipped with an IoT device 406, 408, and 410. The IoT gateway 404 is in communications with each of the IoT devices 406, 408, and 410 over communications links 412, which may be, for example, Bluetooth links, Bluetooth low energy (BLE) links, or any number of other types of communications links. The IoT gateway 404 may also have a wireless local area network (WLAN) link 414 to an IoT infrastructure 416. In this example, the IoT infrastructure 416, may be a warehouse tracking system in communication with a centralized information system 418. This may provide the centralized information system 418 with an accurate inventory and location for each sub-asset in the warehouse.

As a further example, the IoT gateway 404 on the pallet of packages may also include a WWAN radio for cellular communications while in transit. The IoT gateway 404 may collect detailed information from the IoT devices 406, 408, and 410 attached to each sub-asset. The IoT gateway 404 may send information to the centralized information system 418 about the status, e.g., location and integrity, of the shipment and its sub-asset packages.

The IoT gateway 404 may be programmed to evaluate sensor readings from the IoT devices 406, 408, and 410 and either provide a periodic health check or an event driven alert. Further, the IoT gateway 404 may be used to support mission changes, such if the initial recipient sells the asset while it is in transit. For example, the IoT gateway 404 may reassign a portion of its sub-assets to a different IoT gateway if some of the sub-assets are sold in transit and rerouted. In this instance, the IoT gateway 404 could be re-programmed with, for example, a revised route plan for geofencing. Geofencing involves comparing a shipment location to a planned route and then generating an exception when a location reading is sufficiently divergent from the planned route as to suggest a problem. Although geofencing can be implemented by comparing reported locations to a planned route at a remote system, this would require a continuous communication link that may not be available. Geofencing implemented in the IoT gateway 404 may provide an opportunity to detect exceptions faster and when communications links are unreliable.

The IoT gateway 404 may also monitor the sensors on the IoT devices 406, 408, and 410 associated with the sub-assets, to collect information about the handling, for example, to determine the projected shelf life of a cold-chained load. In this example, the information may be cross-referenced with market data for potential markets and route cost estimates to determine the optimal market opportunity for the asset. This may be done in the IoT gateway 404, which may inform the centralized information system 418 of the decision, including revisions of that decision as sub-asset conditions evolve and local route related information is processed.

FIG. 5 is a block diagram of another system 500 for tracking shipments using internet of things IoT devices, in accordance with an embodiment. In this example, a primary asset 502 has a logical primary asset gateway 504 that is in communications with associated sensors 506. The sensors 506 may have processing power or their own, such as IoT devices, or may be simply reporting values, such as temperature, to the logical primary asset gateway 504.

A number of co-associated assets 508 may also be present, each with an IoT gateway 510 that monitors sensors 512 in the co-associated asset. The sensors 512 may be IoT devices that have processing power, or may simply feed data to the IoT gateways 510 for processing. The IoT gateways 510 may communication with the logical primary asset gateway 504 over a physical or radio link 514. Further, the IoT gateways 510 may communicate with each other, for example, forming an ad-hoc network.

The logical primary asset gateway 504 may include a WWAN radio, a WLAN radio, or both to provide a link 516 to an IoT infrastructure 518. The communications between the IoT gateways 510 in the co-associated assets 508 may communicate with the IoT infrastructure 518 through the logical primary asset gateway 504. In some embodiments, the logical primary asset gateway 504 processed the data provided by the IoT gateways 510 in the co-associated assets 508, and makes decisions about association, handling, location, and the like, informing a centralized information system through the IoT infrastructure 518.

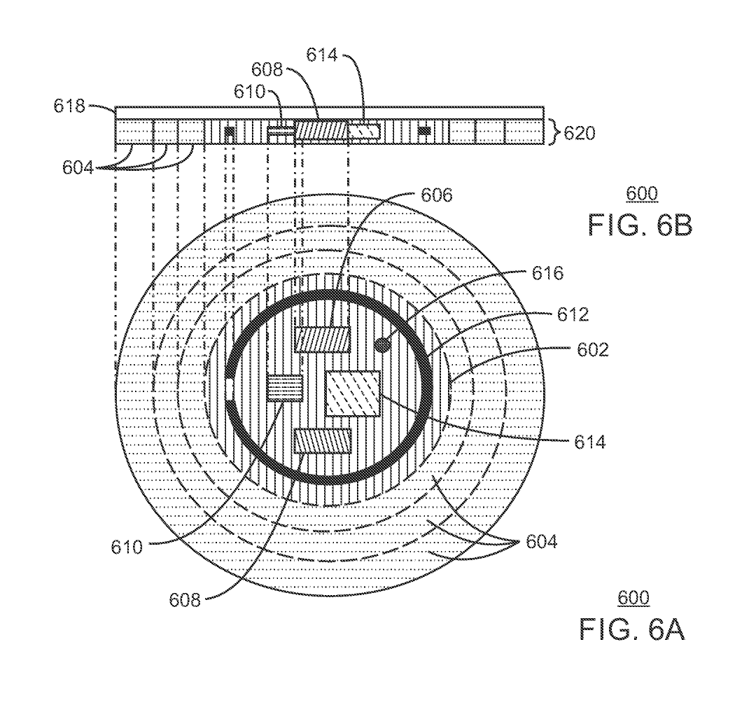

FIGS. 6A and 6B are a top view and a side cross sectional view of an internet of things (IoT) device 600 that may be used in an embodiment. FIG. 6A is a top view of an IoT device 600 that can be attached to an item to track a shipment. The IoT device 600 has a central core 602 that includes the functional components and which may be surrounded by various mechanical devices 604 to assist in attachment. The mechanical devices 604 may include rings that assist in matching the diameter of the device 600 to a material container, sleeve, or item, for example, by being removed to make the diameter of the device smaller than that of the material container, sleeve, or item. However, these may not be used in other embodiments, for example, when the central core 602 is embedded in a package.

The central core 602 may have a number of components to implement the functionality described herein. For example, the central core 602 may be equipped with one or more sensors 606 and 608, for example, to measure environmental conditions, such as temperature and impact, among others. A microcontroller 610, such as a system on a chip (SoC), may be used to obtain the data from the sensors 606 and 608 and communicate over a wireless connection, for example, using an antenna 612.

The microcontroller 610 may be powered by an embedded battery 614. The battery 614 may be selected to provide power for the entire duration of the shipment of the package, including any periods spent in storage. In one embodiment, the wireless antenna 612 may be used to charge the battery 614 in addition to providing a communications link, for example, during storage of the package. The selection of a charging mode versus a network mode may be determined by the presence of an alternating current (AC) charging field. A beacon 616 can be used to alert a user to a problem condition from the IoT device 600, for example, by giving a visible or audible warning. The problematic conditions include, for example, loss of communication with an IoT gateway, or environmental conditions exceeding a preset limit, such as a temperature too high or too low, or an impact beyond a threshold that may have damaged the contents.

In one embodiment, one of the sensor 606 or 608 may be responsive to pressure, for example, a pressure sensitive capacitor or a pressure sensitive resistor. A pressure sensor may be used to determine that a load placed on the package is too high, for example, if packages have been stacked too high. This may allow the IoT device 600 to alert of potential damage to the contents.

FIG. 6B is a side cross sectional view of the device 600. As shown in FIG. 6B, the central core 602 may be contained in an attachable device. For example, the attachable device may be disc shaped, square shaped, or in any other convenient shape. As described with respect to FIG. 6A, the device 600 may be supplied with mechanical devices 604 to assist in attaching the IoT device 600 to a material container or item. The IoT device 600 may be attached to the material container or item through an affixing layer 618. The affixing layer 618 may be a hot melt adhesive, a cyanoacrylate adhesive, a polyurethane adhesive, or any number of other materials. The device may be hermetically sealed in an encapsulation 620 to prevent the infiltration of liquids, such as rainwater. The encapsulation 620 and affixing layer 618 may be designed to be resistant to aggressive operating environments, for example, heat during transit, and the like.

The central core 602 does not have to be permanently mounted to the material container or item. In one embodiment, the central core 602 may be contained in an attachable device which can be fitted to an appropriate mounting point on a package or item. This allows the central core 602 to be reused after the materials are used. Further, the central core 602 may be suitable for attachment to and removal from various types and form factors of items.

The IoT device 600 is not limited to the parts and attachments described with respect to FIGS. 6A and 6B, but may include other systems. For example, the IoT device 600 is not limited to radio communications. In one embodiment, an optical link can be provided for communication between an IoT device and an IoT gateway. In this embodiment, information concerning the material, sensor readings, and the like, may be exchanged through a light emitting diode and phototransistor combination.

The device 600 may have a sound driver to generate sounds, for example, warning beeps, or tones. For example, the IoT device 600 may be preprogrammed to give an audible warning, for example, if a container loses contact with an IoT gateway.

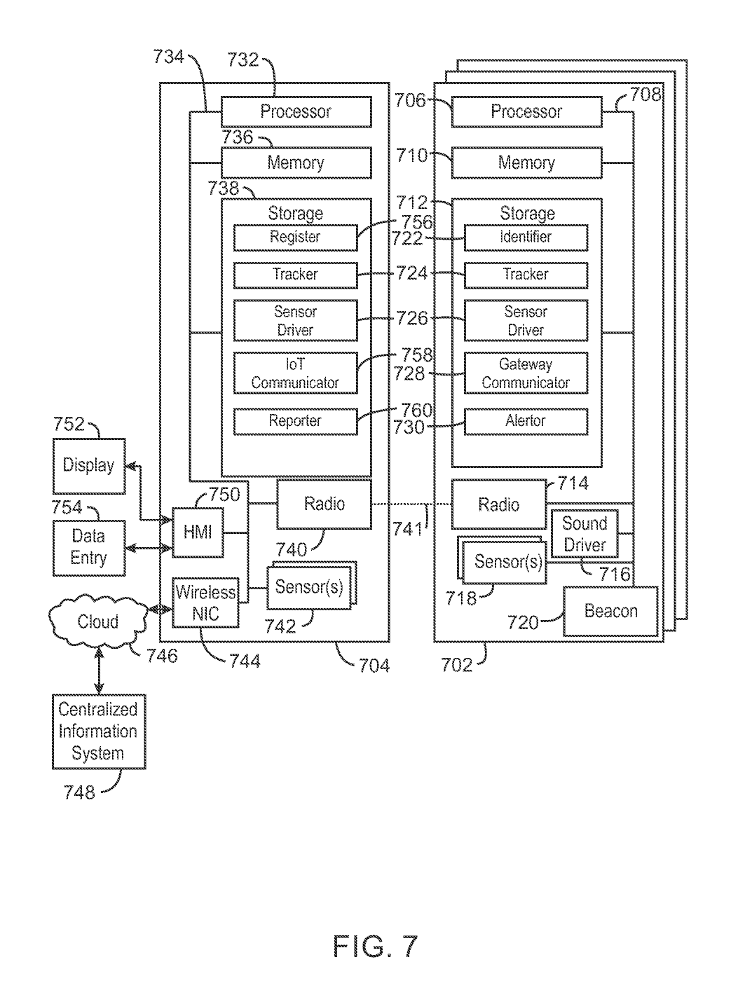

FIG. 7 is a block diagram of IoT devices 702 in communication with an IoT gateway 704, in accordance with embodiments. In this figure, the IoT gateway 704 may be used for measuring sensor readings in addition to obtaining sensor readings from the IoT devices 702 themselves.

The IoT devices 702 may use a system on a chip (SoC) to simplify the design of the system 700. A SoC is a single integrated circuit that integrates all of the components needed for functionality. For example, the SoC may have a processor 706 coupled through a bus 708 to a memory 710. The memory 710 may be random access memory (RAM) used for storage of programs and data during operations. A storage device 712 may include read only memory (ROM), or other types of devices such as electrically programmable ROM (EPROM), flash memory, and the like. The SoC may include a number of other functions, such as a radio 714, which may be a Bluetooth, WLAN, a BLE, a WWAN, or any number of other radio communication devices, as described herein.

The SoC may also include analog to digital convertors (ADCs) and digital to analog convertors (DACs) to drive a sound driver 716, the sensors 718, and a beacon 720. Other units may be present, such as a photodetector to work with the beacon 720 to form an optical communications link. The sound driver 716 may be included to provide alert signals, such as to alert on a loss of communications to the IoT gateway 704.

The storage device 712 is a non-transitory machine readable medium that may include a number of functional blocks or modules to provide the functionality needed. The functional blocks may include an identifier 722 that broadcasts an identity and other information concerning the item, such as storage temperature. A tracker 724 may use the radio 714 to regularly contact the IoT gateway 704, other IoT devices 702, or both, to establish the location and ensure communications are present. A sensor driver 726 may access the sensors 718 and obtain readings, such as impact, temperature, and the like. A gateway communicator 728 may be used to send data to the IoT gateway 704, for example, through the radio 714. An alertor 730 may activate the beacon 720, the sound driver 716, or both, if alarm conditions are detected, such as data that exceeds preset limits or a loss of communications with the IoT gateway 704. Other functions that are not shown include various infrastructure functions, such as charging a battery, alerting a user to a low battery, and the like.

The IoT gateway 704 includes a processor 732 that communicates through a bus 734 with a memory 736. The IoT gateway may also use a SoC, or may use any number of other types of processors, including, for example, a single core chip, a multicore processor, a processor cluster, and the like. The bus 734 may include any number of bus technologies, such as a peripheral component interconnect express (PCIe) bus, a peripheral component interconnect (PC)I bus, a proprietary bus, or any number of others. The memory 736 is used for short term storage of operating programs and results, and may include dynamic RAM, static RAM, or any number of other memory technologies.

The processor 732 may communicate with a storage device 738 over the bus 734. The storage device 738 may be used for longer term storage of program modules, e.g., functioning as a non-transitory machine readable medium. The storage device 738 may include a hard drive, an optical drive, a flash drive, or any number of other technologies.

A radio 740 may be used to communicate with the IoT devices 702 over a radio link 741. The communications may be between the IoT gateway 704 and individual IoT devices 702, or as part of an ad-hoc network with a group of IoT devices 702. The IoT gateway 704 may also include sensors 742, for example, to monitor the temperature of a shipment, among other things. A wireless network interface controller (NIC) 744 may be used to communicate with a computing cloud 746, such as an IoT infrastructure. A centralized information system 748 can be coupled with the cloud 746 to provide storage and data to the IoT gateway 704, as well as providing an interface to the shippers and customers, among other functions.

A human-machine interface (HMI) 750 may be used to couple the IoT gateway 704 to a display 752 and a data entry unit 754. The display 752 and data entry unit 754 may be integrated into a single touch screen unit, for example, in a cellphone, tablet, or local controller. The HMI 750 may be used to alert to a problematic condition, such as a loss of communications to an IoT device 702, or a handling condition, such as a high impact or temperature, among others.

The storage device 738 can include a number of code blocks to provide functionality to the IoT gateway 704 in the system 700. Several of these code blocks perform analogous functions to similar code blocks in the IoT device 702, such as the tracker 724 and the sensor driver 726. A register 756 can record the identity and other information provided from the identifier 722. An IoT communicator 758 can manage communications to and between IoT devices 702, for example, directing the IoT devices 702 to establish an ad-hoc network. The IoT communicator 758 may also manage communications to other IoT gateways, for example, to reassign IoT devices 702 associated with items to those IoT gateways.

The system 700 is not limited to the devices or configurations shown. For example, the IoT devices 702 may themselves locate other IoT devices 702. Further, the IoT gateway 704 may not be a separate unit, but may be part of the infrastructure of a shipping medium, such as a truck, railroad engine, ship, and the like. Further, the IoT devices 702 may include display devices that can report identity, alerts, and other information.

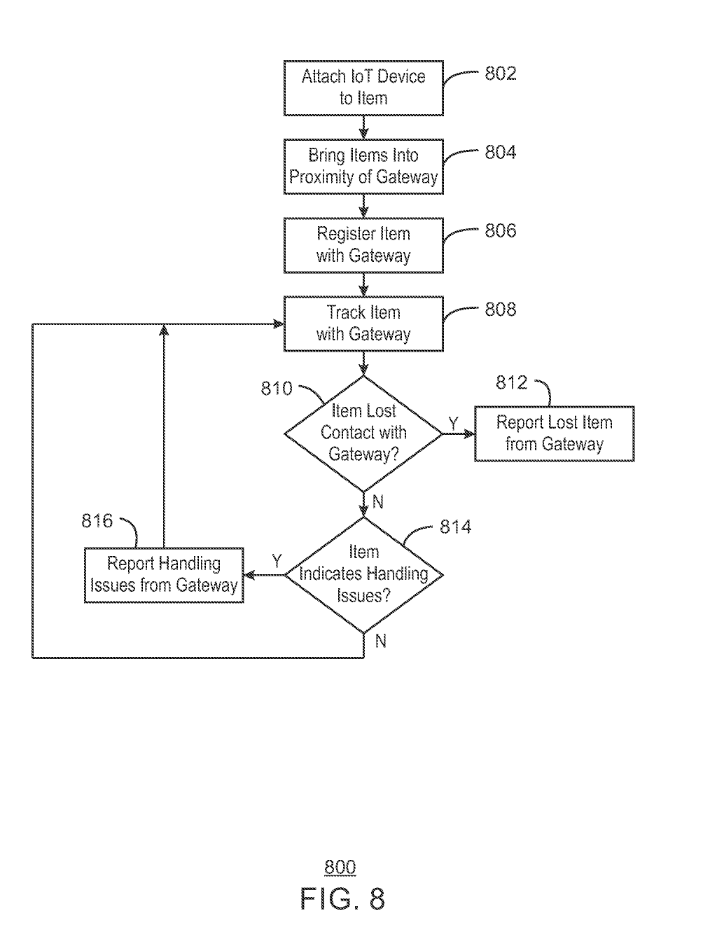

FIG. 8 is a method 800 for tracking shipments with IoT devices, in accordance with embodiments. The method begins at block 802 with the attachment of an IoT device to an item, such as a package. At block 804, the item, including the IoT device, is brought into the proximity of an IoT gateway. At block 806, the item is registered with the IoT gateway. At block 808, the IoT device associated with the item is tracked by the IoT gateway.

At block 810, a determination is made as to whether the IoT device associated with the item has lost contact with the IoT gateway. This may be due to a low battery, too great of a distance, or any number of reasons. Accordingly, in some examples, the IoT gateway may use an ad-hoc network to query other IoT devices on other items to determine if any other IoT devices are in communication with the missing item. At block 812, the IoT gateway reports the loss of the item.

If the IoT device associated with the item is still in communications with the IoT gateway, at block 814, a determination is made as to whether sensor readings, from the IoT device associated with the item or the IoT gateway, indicates a handling issue, such as too high of an impact, too high a temperature, and the like. If so, at block 816, the IoT gateway reports the handing issue. If no handling issue is identified, process flow returns to block 808 to continue monitoring the item.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Example 1 includes an apparatus for An apparatus for tracking a shipment including: an Internet of Things (IoT) gateway, including: a communications link to an IoT infrastructure; and a communications link to a plurality of IoT devices each disposed proximate to an asset; and the plurality of IoT devices, each including a communications link to the IoT gateway.

Example 2 incorporates the subject matter of Example 1. In this example, the apparatus includes a sensor to measure an impact on the asset.

Example 3 incorporates the subject matter of any combination of Examples 1-2. In this example, the apparatus includes a sensor to measure a temperature of the asset.

Example 4 incorporates the subject matter of any combination of Examples 1-3. In this example, the apparatus includes a sensor to measure a pressure of the asset.

Example 5 incorporates the subject matter of any combination of Examples 1-4. In this example, the apparatus includes an ad-hoc network formed between the plurality of IoT devices.

Example 6 incorporates the subject matter of any combination of Examples 1-5. In this example, the IoT gateway is to inform a centralized information system if communications to an IoT device on an asset is lost.

Example 7 incorporates the subject matter of any combination of Examples 1-6. In this example, the IoT gateway includes a wireless wide area network (WWAN) radio.

Example 8 incorporates the subject matter of any combination of Examples 1-7. In this example, the IoT gateway includes a satellite uplink/downlink.

Example 9 incorporates the subject matter of any combination of Examples 1-8. In this example, the apparatus includes an IoT gateway that includes a processor; a communications device to communicate with an IoT infrastructure; a second communications device to communicate with the plurality of IoT devices; and a storage device including instructions to direct the processor to: determine if an IoT device is in communications with the IoT gateway; and alert a centralized information system in a computing cloud if the IoT device is not in communications with the IoT gateway.

Example 10 incorporates the subject matter of any combination of Examples 1-9. In this example, the storage device of example 9 includes instructions to alert the centralized information system if the IoT device reports a sensor reading that is outside of preset limits.

Example 11 incorporates the subject matter of any combination of Examples 1-10. In this example, the apparatus includes an IoT device that includes: a processor; a communications device to communicate with the IoT gateway; and a storage device including instructions to direct the processor to: determine if the IoT device is in communications with the IoT gateway; and activate an alert if not in communication with the IoT gateway.

Example 12 incorporates the subject matter of any combination of Examples 1-11. In this example, the IoT device includes a sensor to measure an environmental condition, and the storage device includes instructions to direct the processor to inform the IoT gateway if preselect limits on the environmental condition are exceeded.

Example 13 incorporates the subject matter of any combination of Examples 1-12. In this example, the apparatus includes a temperature sensor, a pressure sensor, or an accelerometer, or any combinations thereof.

Example 14 incorporates the subject matter of any combination of Examples 1-13. In this example, the apparatus includes an audible alerting device, a visible alerting device, or both.

Example 15 incorporates the subject matter of any combination of Examples 1-14. In this example, the IoT device is hermetically sealed.

Example 16 incorporates the subject matter of any combination of Examples 1-15. In this example, the apparatus includes a battery, wherein the battery is built into the IoT device.

Example 17 incorporates the subject matter of any combination of Examples 1-16. In this example, the apparatus includes a display device on the IoT device.

Example 18 incorporates the subject matter of any combination of Examples 1-17. In this example, the apparatus includes a visible beacon, an auditory alarm, or both.

Example 19 incorporates the subject matter of any combination of Examples 1-18. In this example, the apparatus includes a radio communications device.

Example 20 incorporates the subject matter of any combination of Examples 1-19. In this example, the apparatus includes a radio communications device that includes a WiFi device, a Bluetooth device, a low energy Bluetooth device, a radio network device, or any combinations thereof.

Example 21 includes a method for monitoring assets, including communicating with an Internet of Things (IoT) device attached to an asset from an IoT gateway; and alerting a centralized information system when an actionable issue is detected.

Example 22 incorporates the subject matter of Example 21. In this example, the method includes determining that the IoT device has lost contact with the IoT gateway; and alerting the centralized information system that contact has been lost.

Example 23 incorporates the subject matter of any combination of Examples 21-22. In this example, the method includes receiving a notification from the IoT device that a sensor reading has exceeded a preset limit; and alerting the centralized information system.

Example 24 incorporates the subject matter of any combination of Examples 21-23. In this example, the method includes establishing an ad hoc network between a plurality of IoT devices.

Example 25 incorporates the subject matter of any combination of Examples 21-24. In this example, the method determining a location for each of the plurality of IoT devices by mapping a number of hops for each message in the ad hoc network to reach each of the plurality of the IoT devices from the IoT gateway.

Example 26 incorporates the subject matter of any combination of Examples 21-25. In this example, the method includes measuring pressure on a package with a pressure sensor.

Example 27 includes a non-transitory, machine readable medium, including instructions to direct a processor to communicate with an Internet of Things (IoT) device; and alert a centralized information system if contact to the IoT device is lost.

Example 28 incorporates the subject matter of Example 27. In this example, the non-transitory, machine readable medium includes instructions to direct a processor to receive an alert on a sensor reading from an IoT device; and report the alert to the centralized information system.

Example 29 incorporates the subject matter of any combination of Examples 27-28. In this example, the non-transitory, machine readable medium includes instructions to direct the processor to establish an ad hoc network between a plurality of IoT devices.

Example 30 incorporates the subject matter of any combination of Examples 27-29. In this example, the non-transitory, machine readable medium includes instructions to direct the processor to alert the centralized information system if a shipment is rerouted.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. An apparatus for tracking a shipment comprising:
an Internet of Things (IoT) gateway, comprising:
a communications link to an IoT infrastructure; and
a communications link to a plurality of IoT devices each disposed proximate to an asset; and
the plurality of IoT devices, each comprising a communications link to the IoT gateway.

2. The apparatus of claim 1, comprising a sensor to measure an impact on the asset.

3. The apparatus of claim 1, comprising a sensor to measure a temperature of the asset.

4. The apparatus of claim 1, wherein the IoT gateway is to inform a centralized information system if communications to an IoT device on an asset is lost.

5. The apparatus of claim 1, wherein the IoT gateway comprises a wireless wide area network (WWAN) radio.

6. The apparatus of claim 1, wherein the IoT gateway comprises a satellite uplink/downlink.

7. The apparatus of claim 1, wherein an IoT gateway comprises:
a processor;
a communications device to communicate with an IoT infrastructure;
a second communications device to communicate with the plurality of IoT devices; and
a storage device comprising instructions to direct the processor to:
determine if an IoT device is in communications with the IoT gateway; and
alert a centralized information system in a computing cloud if the IoT device is not in communications with the IoT gateway.

8. The apparatus of claim 7, wherein the storage device comprises instructions to alert the centralized information system if the IoT device reports a sensor reading that is outside of preset limits.

9. The apparatus of claim 1, wherein an IoT device comprises:
a processor;
a communications device to communicate with the IoT gateway; and
a storage device comprising instructions to direct the processor to:
determine if the IoT device is in communications with the IoT gateway; and
activate an alert if not in communication with the IoT gateway.

10. The apparatus of claim 9, wherein the IoT device comprises a sensor to measure an environmental condition, and the storage device comprises instructions to direct the processor to inform the IoT gateway if preselect limits on the environmental condition are exceeded.

11. The apparatus of claim 9, comprising an audible alerting device, a visible alerting device, or both.

12. The apparatus of claim 9, wherein the IoT device is hermetically sealed.

13. The apparatus of claim 1, comprising a visible beacon, an auditory alarm, or both.

14. The apparatus of claim 1, comprising a radio communications device.

15. The apparatus of claim 14, wherein the radio communications device comprises a WiFi device, a Bluetooth device, a low energy Bluetooth device, a radio network device, or any combinations thereof.

16. A method for monitoring assets, comprising:
communicating with an Internet of Things (IoT) device attached to an asset from an IoT gateway; and
alerting a centralized information system when an actionable issue is detected.

17. The method of claim 16, comprising:
determining that the IoT device has lost contact with the IoT gateway; and
alerting the centralized information system that contact has been lost.

18. The method of claim 16, comprising:
receiving a notification from the IoT device that a sensor reading has exceeded a preset limit; and
alerting the centralized information system.

19. The method of claim 16, comprising establishing an ad hoc network between a plurality of IoT devices.

20. The method of claim 19, comprising determining a location for each of the plurality of IoT devices by mapping a number of hops for each message in the ad hoc network to reach each of the plurality of the IoT devices from the IoT gateway.

21. The method of claim 16, comprising measuring pressure on a package with a pressure sensor.

22. A non-transitory, machine readable medium, comprising instructions to direct a processor to:
communicate with an Internet of Things (IoT) device; and
alert a centralized information system if contact to the IoT device is lost.

23. The non-transitory, machine readable medium of claim 22, comprising instructions to direct a processor to:
receive an alert on a sensor reading from an IoT device; and
report the alert to the centralized information system.

24. The non-transitory, machine readable medium of claim 22, comprising instructions to direct the processor to establish an ad hoc network between a plurality of IoT devices.

25. The non-transitory, machine readable medium of claim 22, comprising instructions to direct the processor to alert the centralized information system if a shipment is rerouted.
